(19) United States
(12) Patent Application Publication
(10) Pub. No.: US 2024/0249885 A1
(43) Pub. Date: Jul. 25, 2024

(54) MULTILAYER CERAMIC ELECTRONIC COMPONENT

(71) Applicant: Murata Manufacturing Co., Ltd., Nagaokakyo-shi (JP)

(72) Inventors: Naoki MIKATA, Nagaokakyo-shi (JP); Tatsunori YASUDA, Nagaokakyo-shi (JP)

(21) Appl. No.: 18/624,446

(22) Filed: Apr. 2, 2024

Related U.S. Application Data
(63) Continuation of application No. PCT/JP2023/029511, filed on Aug. 15, 2023.

(30) Foreign Application Priority Data
Oct. 3, 2022 (JP) 2022-159600

(51) Int. Cl. H01G 4/232; H01G 4/012; H01G 4/12; H01G 4/30

(52) U.S. Cl. CPC H01G 4/2325; H01G 4/012; H01G 4/1227; H01G 4/1236; H01G 4/30

(57) ABSTRACT

A multilayer ceramic electronic component includes ceramic layers including Ca and Zr as main components, first and second external electrodes including a first base electrode layer and second base electrode layer, and a plated layer covering a portion of the first and second base electrode layers, the first and second base electrode layers include Cu as a main component, a multilayer body includes at an edge portion in a lamination direction a first compound region extending to a first end surface and a second compound region extending to the second end surface, the first compound region is joined with the first base electrode layer, the second compound region is joined with the second base electrode layer, and the first compound region and second compound region are not joined to each other.

### CROSS REFERENCE TO RELATED APPLICATIONS

This application claims the benefit of priority to Japanese Patent Application No. 2022-159600 filed on Oct. 3, 2022 and is a Continuation Application of PCT Application No. PCT/JP2023/029511 filed on Aug. 15, 2023. The entire contents of each application are hereby incorporated herein by reference.

### BACKGROUND OF THE INVENTION

### 1. Field of the Invention

The present invention relates to multilayer ceramic electronic components, and in particular, to multilayer ceramic capacitors.

### 2. Description of the Related Art

In recent years, the dimensions of electronic components are becoming smaller accompanying the miniaturization of electronic devices with multilayer ceramic electronic components mounted therein. In addition, in the case of the multilayer ceramic electronic component being a multilayer ceramic capacitor, when the device in which the multilayer ceramic capacitor is mounted drops from a certain height, or when deflection from the substrate is transmitted to the multilayer ceramic electronic component, there is a problem in that the external electrodes may peel off. As a countermeasure to this problem, Japanese Unexamined Patent Application, Publication No. 2018-182107 describes improving the bonding strength between a multilayer chip and external electrode by providing a glass component layer between the multilayer chip and external electrode.

However, in the case of providing a glass component layer, since glass is insulating, the equivalent series resistance (ESR) of the multilayer ceramic capacitor increases.

### SUMMARY OF THE INVENTION

Example embodiments of the present invention provide multilayer ceramic electronic components such as multilayer ceramic capacitors each with improved bonding force between a multilayer body and a base electrode layer, without increasing the ESR within external electrodes.

A multilayer ceramic electronic component according to an example embodiment of the present invention includes a multilayer body including a plurality of ceramic layers that are laminated, the plurality of ceramic layers including Ca and Zr as main components, a first main surface and a second main surface opposing each other in a lamination direction, a first lateral surface and a second lateral surface opposing each other in a width direction that is orthogonal or substantially orthogonal to the lamination direction, a first end surface and a second end surface opposing each other in a length direction that is orthogonal or substantially orthogonal to the lamination direction and the width direction, a first internal electrode layer alternately laminated with the plurality of ceramic layers, and exposed at the first end surface, and a second internal electrode layer alternately laminated with the plurality of ceramic layers, and exposed at the second end surface, a first external electrode extending from the first end surface to the first main surface and the second main surface, and a second external electrode extending from the second end surface to the first main surface and the second main surface, in which the first external electrode and the second external electrode include a first base electrode layer and a second base electrode layer, and a plated layer covering a portion of the first base electrode layer and the second base electrode layer, the first base electrode layer and the second base electrode layer include Cu as a main component, the multilayer body includes, at an edge portion in the lamination direction, a first compound region extending to the first end surface, and a second compound region extending to the second end surface, the first compound region is joined with the first base electrode layer, the second compound region is joined with the second base electrode layer, and the first compound region and the second compound region are not joined to each other.

According to example embodiments of the present invention, it is possible to provide multilayer ceramic electronic components such as multilayer ceramic capacitors each with improved bonding force between a multilayer body and a base electrode layer, without increasing the ESR within external electrodes.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a multilayer ceramic electronic component according to an example embodiment of the present invention.

FIG. 2 is a cross-sectional view along the line I-I in FIG. 1.

FIG. 3 is a cross-sectional view along the line II-II in FIG. 1.

FIG. 4 is a cross-sectional view along the line in FIG. 1.

FIG. 5 is a view corresponding to the cross-sectional view along the line I-I in FIG. 1 illustrating a dummy electrode.

FIG. 6 is a table showing characteristics of a multilayer ceramic electronic component according to an example embodiment of the present invention.

### DETAILED DESCRIPTION OF THE EXAMPLE EMBODIMENTS

Example embodiments of the present invention will be described in detailed below with reference to the drawings.

Hereinafter, an example embodiment of a multilayer ceramic electronic component 1 according to the present invention will be explained by referencing the attached drawings. In the following explanation, a case of the multilayer ceramic electronic component 1 being a multilayer ceramic capacitor will be explained as an example. The same reference symbols will be used for the same or corresponding portions in the respective drawings.

### Exterior Shape of Multilayer Ceramic Electronic Component

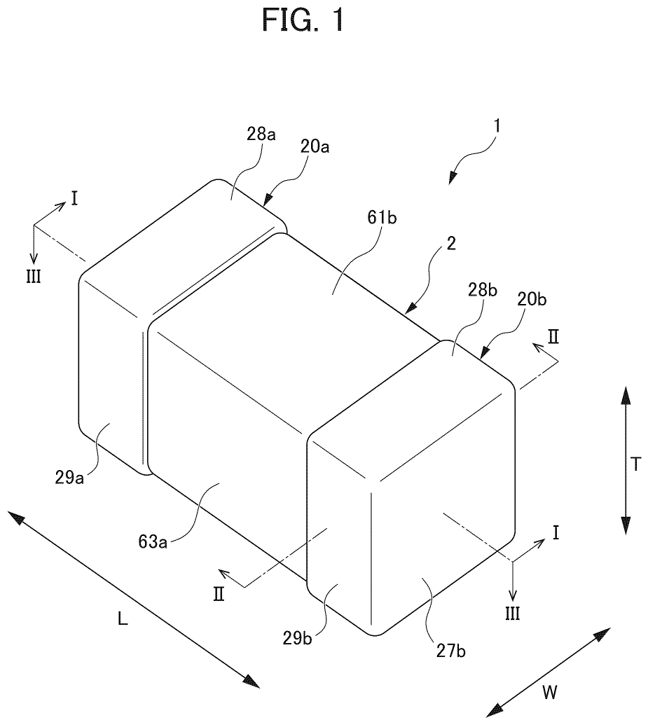

An outline of the appearance of the multilayer ceramic electronic component 1 will be explained based on FIG. 1. FIG. 1 is a perspective view showing a multilayer ceramic electrical component 1 according to the present example embodiment. The multilayer ceramic electronic component 1 includes a multilayer body 2 and an external electrode 20. The external electrode 20 includes a first external electrode 20a and a second external electrode 20b.

### Definition of Directions

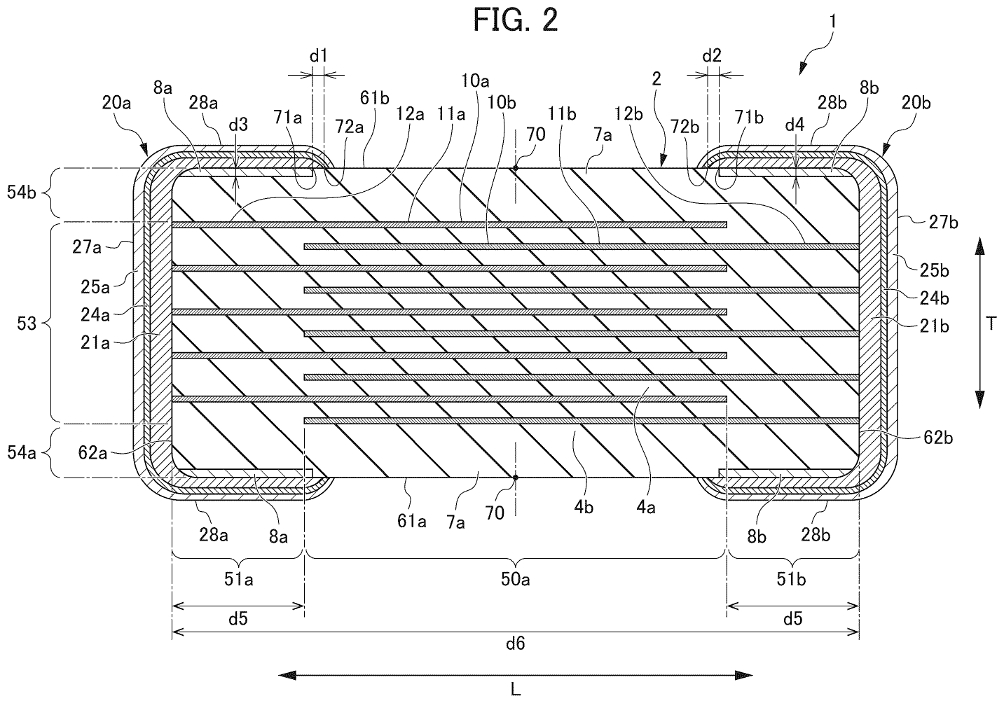

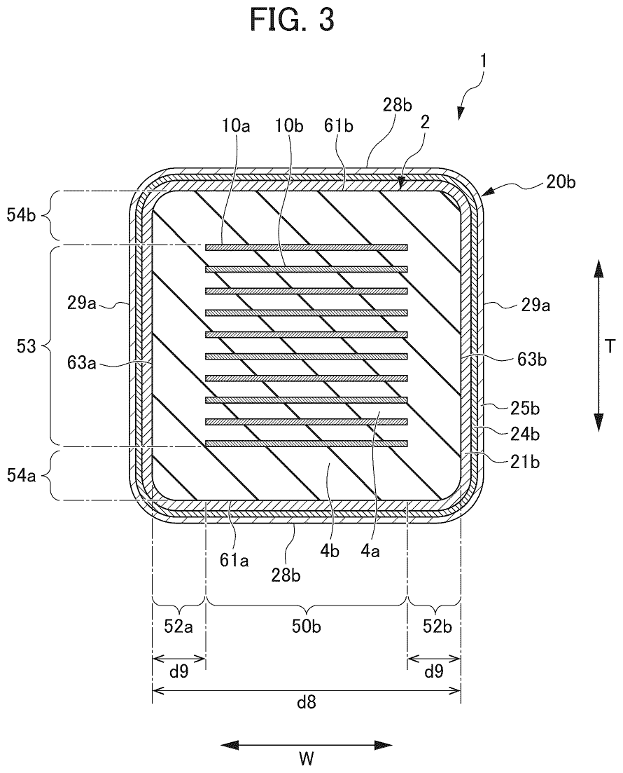

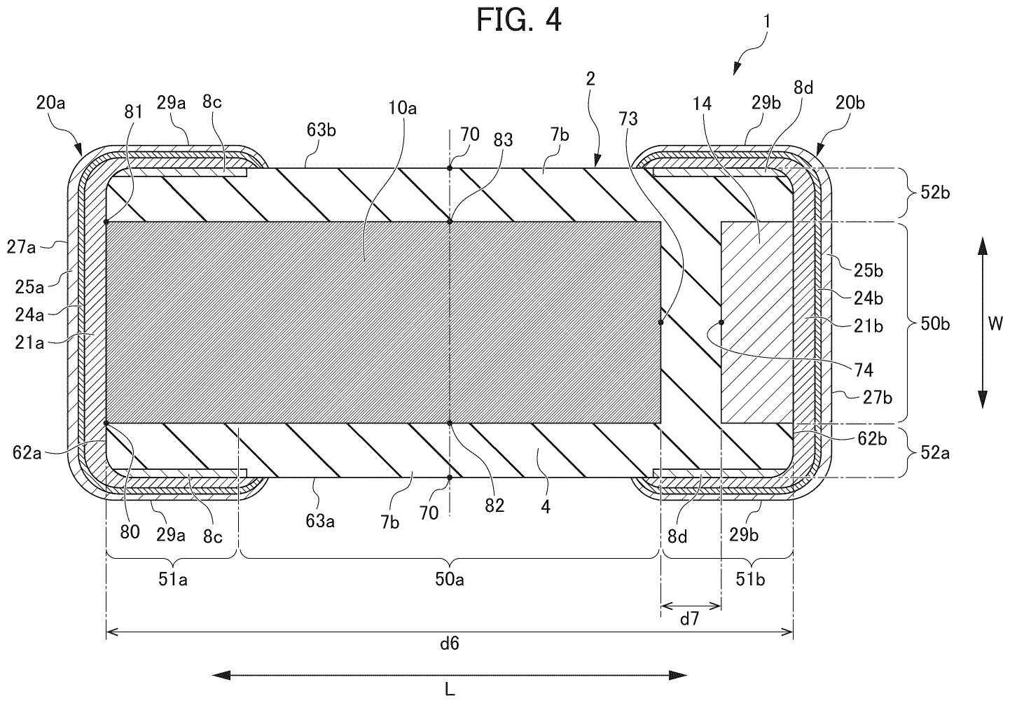

The drawings show an L direction, a W direction and a T direction as appropriate. The L direction is a length direction L of a multilayer ceramic electronic component 1. The W direction is width direction W of the multilayer ceramic electronic component 1. The T direction is a lamination direction T of the multilayer ceramic electronic component 1. The cross section shown in FIG. 2 is thereby called an LT cross section, the cross section shown in FIG. 3 is called a WT cross section, and the cross section shown in FIG. 4 is called an LW cross section. The length direction L, width direction W and lamination direction T may not necessarily be in an orthogonal relationship with each other. The length direction L, width direction W and lamination direction T may be a relationship intersecting with each other.

### Outer Shape of Multilayer Body

The multilayer body 2 includes a rectangular or substantially rectangular parallelepiped shape. The multilayer body 2 includes two main surfaces 61, two end surfaces 62, and two lateral surfaces 63. The main surfaces 61 are opposed to each other in the lamination direction T. The end surfaces 62 are opposed to each other in the length direction L. The lateral surfaces 63 are opposed to each other in the width direction W. One of the two main surfaces 61 is a first main surface 61a and the other is a second main surface 61b. One of the two end surfaces 62 is a first end surface 62a and the other is a second end surface 62b. One of the two lateral surfaces 63 is a first lateral surface 63a, and the other lateral surface is a second lateral surface 63b.

Ridge portions and corner portions of the multilayer body 2 are preferably rounded. Each of the ridge portions is a portion where two surfaces of the multilayer body 2 intersect. Each of the corner portions is a portion where three surfaces of the multilayer body 2 intersect. The size of the multilayer body 2 is not particularly limited.

### Configuration of Multilayer Body

The multilayer body 2 includes a plurality of ceramic layers 4 and a plurality of internal electrode layers 10. Hereinafter, the configuration of the multilayer body 2 will be described with reference to a cross-sectional view of the multilayer body 2.

### Internal Configuration of Multilayer Body (LT Cross Section)

The internal configuration of the multilayer body 2 will be described with reference to FIG. 2. FIG. 2 is a cross-sectional view taken along the line I-I of the multilayer ceramic electronic component 1 shown in FIG. 1. FIG. 2 shows an LT cross section of the multilayer ceramic electronic component 1. The multilayer body 2 includes the plurality of ceramic layers 4 and the plurality of internal electrode layers 10, as shown in FIG. 2. The plurality of ceramic layers 4 and the plurality of internal electrode layers 10 are laminated on each other in the lamination direction T.

### Inner Layer Portion and Outer Layer Portion

The multilayer body 2 is divided into an inner layer portion 53 and two outer layer portions 54 in the lamination direction T. The outer layer portions 54 include a first outer layer portion 54a and a second outer layer portion 54b. The first outer layer portion 54a and the second outer layer portion 54b sandwich the inner layer portion 53 in the lamination direction T.

The inner layer portion 53 includes a portion of the plurality of ceramic layers 4 and the plurality of internal electrode layers 10. The inner layer portion 53 includes the plurality of internal electrode layers 10 that are opposed to each other with the ceramic layer 4 interposed therebetween. Therefore, a capacitance is generated in the inner layer portion 53. Therefore, the inner layer portion 53 substantially defines and functions as a capacitor in the multilayer body 2. The inner layer portion 53 is thus referred to as an effective portion.

The first outer layer portion 54a is a portion of the outer layer portions 54 adjacent to the first main surface 61a of the multilayer body 2. Among the outer layer portions 54, the second outer layer portion 54b is a portion adjacent to the second main surface 61b of the multilayer body 2. Specifically, the first outer layer portion 54a is located between the first main surface 61a and an internal electrode layer 10 closest to the first main surface 61a among the plurality of internal electrode layers 10. The second outer layer portion 54b is located between the second main surface 61b and an internal electrode layer 10 closest to the second main surface 61b among the plurality of internal electrode layers 10. The first outer layer portion 54a and the second outer layer portion 54b do not include the internal electrode layers 10. The first outer layer portion 54a and the second outer layer portion 54b include the ceramic layers 4 except for the ceramic layers 4 for the inner layer portion 53 among the plurality of ceramic layers 4. Each of the first outer layer portion 54a and the second outer layer portion 54b functions as a protective layer of the inner layer portion 53.

### Ceramic Layer

The ceramic layers 4 can be classified into a ceramic layer 4 provided in the inner layer portion 53 and a ceramic layer 4 provided in the outer layer portion 54. The ceramic layers 4 in the inner layer portion 53 are referred to as inner ceramic layers 4a. The ceramic layer 4 in each of the outer layer portions 54 is referred to as an outer ceramic layer 4b.

### Inner Ceramic Layer

The inner ceramic layer 4a is located between the internal electrode layers 10. More specifically, the inner ceramic layer 4a is located between a first internal electrode layer 10a and a second internal electrode layer 10b. Then, the inner ceramic layer 4a defines an inner layer portion 53 along with the internal electrode layer 10.

### Outer Ceramic Layer

The outer ceramic layer 4b is located between the first main surface 61a and the internal electrode layer 10 closest to the first main surface 61a, and between the second main surface 61b and the internal electrode layer 10 closest to the second main surface 61b. The outer ceramic layer 4b defines a first outer layer portion 54a and a second outer layer portion 54b.

### Number of Ceramic Layers

The number of ceramic layers 4 laminated in the multilayer body 2, for example, can be set to at least 5 and no more than 2000. This number of ceramic layers 4 is a number including the number of inner ceramic layers 4a and number of outer ceramic layers 4b.

### Material of Ceramic Layer

As a material of the ceramic layer 4, for example, a dielectric ceramic made of a main component such as BaTiO₃, CaTiO₃, SrTiO₃, or CaZrO₃ can be used. Further, for example, a material obtained by adding a subcomponent such as a Mn compound, an Fe compound, a Cr compound, a Co compound, or a Ni compound to these main components may be used.

The ceramic layer 4 may include a plurality of crystal grains including, for example, a perovskite compound with BaTiO₃ as a basic structure. A thinner thickness of ceramic layer 4 provides greater capacitance as a capacitor. For this reason, the crystal grain size is, for example, preferably no more than about 1 um. On the other hand, as the thickness of the ceramic layer becomes thinner, the crystal grains become smaller. When the crystal particles are too small, it leads to a decline in relative permittivity due to size effect. For this reason, the size of crystal grains is preferably set as appropriate according to the thickness of the ceramic layer.

In the case of using a piezoelectric ceramic in the multilayer body 2, the multilayer ceramic electronic component defines and functions as a ceramic piezoelectric element. As specific examples of the piezoelectric ceramic material, for example, a PZT (lead zirconate titanate)-based ceramic material or the like can be used.

In the case of using a semiconductor ceramic material in the multilayer body 2, the multilayer ceramic electronic component defines and functions as a thermistor. As specific examples of the semiconductor ceramic material, for example, a spinel-based ceramic material or the like can be used.

In the case of using a magnetic ceramic in the multilayer body, the multilayer ceramic electronic component defines and functions as an inductor. In addition, in the case of the multilayer ceramic electronic component defining and functioning as an inductor element, the internal electrode layer is a coil conductor. As a specific example of the magnetic ceramic material, for example, a ferrite ceramic material or the like can be exemplified.

### Thickness of Ceramic Layer

The thickness of the ceramic layer 4 can be set to at least about 0.3 um and no more than about 100 um, for example. In addition, the outer ceramic layer 4b may include several layers, or may include a single layer.

### Internal Electrode Layer

The internal electrode layer 10 can be classified into a first internal electrode layer 10a and a second internal electrode layer 10b. The first internal electrode layer 10a is an internal electrode layer 10 connected to the first external electrode 20a. The second internal electrode layer 10b is an internal electrode layer 10 connected to the second external electrode 20b. The first internal electrode layer 10a extends from the first end surface 62a towards the second end surface 62b. The second internal electrode layer 10b extends from the second end surface 62b towards the first end surface 62a.

### Opposing Section and Drawn Section

The first internal electrode layer 10a and second internal electrode layer 10b respectively include a counter electrode portion 11 and an extraction electrode portion 12. The counter electrode portion 11 is a portion in the internal electrode layer 10 in which the first internal electrode layer 10a and second internal electrode layer 10b oppose each other in the lamination direction T. The extraction electrode portion 12 is a portion extending out from the counter electrode portion 11 to the first end surface 62a or second end surface 62b of the multilayer body 2, in the internal electrode layer 10.

The counter electrode portion 11 of the first internal electrode layer 10a is a first counter electrode portion 11a. The extraction electrode portion 12 of the first internal electrode layer 10a is a first extraction electrode portion 12. The first extraction electrode portion 12a is a portion extending out from the first counter electrode portion 11a to the first end surface 62a of the multilayer body 2.

Similarly, the counter electrode portion 11 of the second internal electrode layer 10b is a second counter electrode portion 11b. The extraction electrode portion 12 of the second internal electrode layer 10b is a second extraction electrode portion 12b. The second extraction electrode portion 12b is a portion extending out from the second counter electrode portion 11b to the second end surface 62b of the multilayer body 2.

### Number of Internal Electrode Layers

The number of the internal electrode layers 10 can be set to at least 10 and no more than 2000, for example. This number of internal electrode layers 10 is a number including the number of first internal electrode layers 10a and the number of second internal electrode layers 10b.

### Thickness of Internal Electrode Layer

The thickness of the internal electrode layer 10, for example, can be set to at least about 0.1 μm and no more than about 5.0 μm, and is preferably set to at least about 0.2 um and no more than about 2.0 um. In the case of the thickness of the internal electrode layer 10 being at least about 0.5 μm, upon forming the metal layer of the external electrode 20 by plating, the plating film tends to grow.

### Material of Internal Electrode Layer

The material of the internal electrode layer 10, for example, can be a metal such as Ni, Cu, Ag, Pd, and Au, or an alloy of Ni and Cu, or an alloy of Ag and Pd. The material of the internal electrode layer 10 may include dielectric particles with the same composition system as the ceramic included in the ceramic layer 4.

### Electrode Opposing Portion

Sections in the length direction L of the multilayer body 2 will be explained. The multilayer body 2 can be divided into an electrode opposing portion 50 and an L gap 51 in the length direction L. The electrode opposing portion 50 in the section in the length direction L is an L opposing portion 50a. In addition, the L gap 51 includes a first L gap 51a and a second L gap 51b.

The L opposing portion 50a corresponds to a portion at which the first internal electrode layer 10a and the second internal electrode layer 10b oppose each other in the lamination direction T. The L opposing portion 50a is located at a central portion of the multilayer body 2 in the length direction L of the multilayer body 2. In the L opposing portion 50a, the first counter electrode portion 11a and second counter electrode portion 11b are opposed to each other in the lamination direction T via the inner ceramic layer 4a. For this reason, a capacitance is generated in the 1 opposing portion 50a. The L opposing portion 50a is, therefore, an effective portion.

### L Gap

The L gap 51 is a portion in the length direction L of the multilayer body 2 at which the first internal electrode layer 10a and second internal electrode layer 10b are not opposed to each other in the lamination direction T. Then, the first L gap 51a among the L gaps 51 is a portion in which the first internal electrode layer 10a is arranged in the lamination direction T, but the second internal electrode layer 10b is not arranged. In addition, the second L gap 51b among the L gaps 51 is a portion in which the second internal electrode layer 10b is arranged in the lamination direction T, but the first internal electrode layer 10a is not arranged.

The L gap 51 is located between the L opposing portion 50a and first end surface 62a, and between the L opposing portion 50a and second end surface 62b, in the length direction L of the multilayer body 2. Between the L opposing portion 50a and first end surface 62a is the first L gap 51a. In addition, between the L opposing portion 50a and second end surface 62b is the second L gap 51b. The first L gap 51a corresponds to a position at which the first extraction electrode portion 12a is arranged. For this reason, the first L gap 51a defines and functions as a lead-out portion to the first end surface 62a of the first internal electrode layer 10a. The second L gap 51b corresponds to a position at which the second extraction electrode portion 12b is arranged. For this reason, the second L gap 51b defines and functions as a lead out portion to the second end surface 62b of the second internal electrode layer 10b.

The length in the length direction L of the L gap 51, for example, can be set to at least about 10% and no more than about 30% of the length in the length direction L of the multilayer body 2. In addition, the length in the length direction L of the L gap 51, for example, can be set to at least about 5 μm and no more than about 30 μm. The length in the length direction L of the L gap 51 will be explained more specifically later.

The specific configuration of the internal electrode layer 10 and the like can be modified in various ways. For example, the shape of the first counter electrode portion 11a of the first internal electrode layer 10a is not particularly limited. However, it is preferably rectangular or substantially rectangular. However, the corner portions thereof may be rounded. In addition, the corner portions may be oblique. In other words, the corner portions may be tapered. In addition, this tapered shape may have an incline approaching either edge portion of the first counter electrode portion 11a.

Similarly, the shape of the second counter electrode portion 11b of the second internal electrode layer 10b is not particularly limited. However, it is preferably rectangular or substantially rectangular. However, the corner portions thereof may be rounded. In addition, the corner portions may be oblique. In other words, the corner portions may be tapered. In addition, this tapered shape may have an incline approaching either edge portion of the second counter electrode portion 11b.

Similarly, the shape of the first extraction electrode portion 12a of the first internal electrode layer 10a is not particularly limited. However, it is preferably rectangular or substantially rectangular. However, the corner portions thereof may be rounded. In addition, the corner portions may be oblique. In other words, the corner portions may be tapered. In addition, this tapered shape may have an incline approaching either edge portion of the first extraction electrode portion 12a.

Similarly, the shape of the second extraction electrode portion 12b of the second internal electrode layer 10b is not particularly limited. However, it is preferably rectangular or substantially rectangular. However, the corner portions thereof may be rounded. In addition, the corner portions may be oblique. In other words, the corner portions may be tapered. In addition, this tapered shape may have an incline approaching either edge portion of the second extraction electrode portion 12b.

The width of the first counter electrode portion 11a of the first internal electrode layer 10a and the width of the first extraction electrode portion 12a of the first internal electrode layer 10a may be the same or substantially the same. Alternately, either one may have a narrower width.

The width of the second counter electrode portion 11b of the second internal electrode layer 10b and the width of the second extraction electrode portion 12b of the second internal electrode layer 10b may be the same or substantially the same, or either one may have a narrower width.

The first extraction electrode portion 12a of the first internal electrode layer 10a may curve towards the center of the first end surface 62a of the multilayer body 2.

The second extraction electrode portion 12b of the second internal electrode layer 10b may curve towards the center of the second end surface 62b of the multilayer body 2.

The distance between the internal electrode layer 10 closest to the side of the first main surface 61a of the internal electrode layer 10 extending out to each end surface 62, and the internal electrode layer 10 closest to the side of the second main surface 61b may be shorter than the distance between the counter electrode portion 11 closest to the side of the first main surface 61a and the counter electrode portion 11 the most to the side of the second main surface 61b.

In the multilayer ceramic electronic component 1 according to the present example embodiment, the counter electrode portions 11 of the internal electrode layer 10 are opposed via the ceramic layer 4, such that a capacitance is generated therein. The characteristics of a capacitor are thus obtained. In order to generate the capacitance of the capacitor as a high capacitance, it is necessary to increase the surface area of the internal electrode layer 10. For this reason, the coverage of the LW plane of the internal electrode layer 10 is, for example, preferably at least about 90%. Coverage of the LW plane, when viewing the internal electrode layer 10 from the LW plane, is defined by the proportion of the remaining area subtracting the area of space from this area, relative to the area inside of edge of the internal electrode layer 10.

The capacitance of the capacitor becomes higher with higher coverage of the LW plane. In the case of the coverage of the LW plane being low, the ceramic layers 4 are bonded via voids. For this reason, the bonding strength between layers becomes higher. The inter-layer peeling hardly occurs.

In addition, the internal electrode layer 10 preferably has a uniform or substantially uniform thickness. However, the thickness of the edge in the width direction W is thicker than the thickness in the central part in the width direction W.

### Insulation Layer

An insulation layer may be provided on the first lateral surface 63a of the multilayer body 2, and on the second lateral surface 63b. When the insulation layer is provided, an interface between the internal electrode layer 10 and ceramic layer 4 is covered by the insulation layer. It is thus possible to reduce or prevent moisture from penetrating the interface between the internal electrode layer 10 and ceramic layer 4. The insulation layer is preferably a similar component as the ceramic layer 4. However, the material of the insulation layer is not limited thereto.

The insulation layer may be arranged so that the insulation layer bonds with the internal electrode layer 10. In this case, the multilayer body 2 preferably does not include the W gap 52 explained later. This is because the insulation layer and internal electrode layer 10 tend to bond.

### Step Layer

In addition, a step layer may be provided in the L gap 51. The step layer is the ceramic layer 4 provided in addition to the L gap 51, in order to decrease the difference in length in the lamination direction T between the L gap 51 and the L opposing portion 50a. The step layer may be provided so that the internal electrode layer 10 covers a portion of this step layer. Alternatively, contrary to this, the step layer may be provided so as to cover a portion of the internal electrode layer 10. The step layer preferably has the same or similar thickness as the internal electrode layer 10. In addition, the step layer preferably includes the same or similar components as the ceramic layer 4. However, the components of the ceramic layer 4 are not limited thereto.

### Dummy Electrode Layer

The dummy electrode layer may be arranged at the L gap 51. The dummy electrode layer can be arranged to at least one among the inner layer portion 53 and outer layer portion 54. Herein, the outer layer portion 54 includes the first outer layer portion 54a and second outer layer portion 54b. In the case of arranging the dummy electrode layer at the outer layer portion 54, the dummy electrode layer is preferably arranged at a portion corresponding to a location to which the L gap 51 is translated in the lamination direction T. In other words, the dummy electrode layer is preferably arranged at a position corresponding to the L gap 51 in the length direction L of the outer layer portion 54.

The dummy electrode layer can include the first dummy electrode layer and second dummy electrode layer. A dummy electrode layer provided on the same plane as the first internal electrode layer 10a, and exposed at the second end surface 62b is defined as a first dummy electrode layer. The first dummy electrode layer preferably has the same or similar thickness as the sum of the thicknesses of the first internal electrode layers 10a. In other words, the first dummy electrode layer preferably has the same or similar thickness as a value from multiplying the number of first internal electrode layers 10a by the thickness of the first internal electrode layer 10a. In addition, the first dummy electrode can be provided on the same plane as the first internal electrode layer 10a closest to either of the first main surface 61a and second main surface 61b. Alternatively, the first dummy electrode can be provided on both of the same plane as the first internal electrode layer 10a closest to the first main surface 61a, and the same plane as the first internal electrode layer 10a closest to the second main surface 61b.

A dummy electrode layer provided on the same plane as the second internal electrode layer 10b and exposed at the first end surface 62a is defined as a second dummy electrode layer. The second dummy electrode layer is also the same as or similar to the first dummy electrode layer. In other words, the second dummy electrode layer preferably has the same or similar thickness as the sum of the thicknesses of the second internal electrode layers 10b. In other words, the second dummy electrode layer preferably has a thickness the same as or similar to a value achieved by multiplying the number of second internal electrode layers 10b by the thickness of the second internal electrode layer 10b. In addition, the second dummy electrode layer can also be arranged in a similar state as the first dummy electrode layer. Furthermore, the first dummy electrode layer and second dummy electrode layer may both be provided at the outer layer portion 54.

### External Electrode

The external electrode 20 includes a first external electrode 20a and a second external electrode 20b.

### First External Electrode

The first external electrode 20a is the external electrode 20 provided at the first end surface 62a of the multilayer body 2. The first external electrode 20a is electrically connected with the first internal electrode layer 10a.

### Second External Electrode

The second external electrode 20b is the external electrode 20 provided at the second end surface 62b of the multilayer body 2. The second external electrode 20b is electrically connected with the second internal electrode layer 10b.

### External Electrode of Each Surface

The external electrode 20 extends from one end surface 62 to a portion of two main surfaces 61 and a portion of two lateral surfaces 63. Among the external electrodes 20, a portion arranged at the end surface 62 is defined as an end-surface external electrode 27. Among the external electrode 20, a portion arranged at a portion of the main surface 61 is defined as a main-surface external electrode 28. Among the external electrode 20, a portion arranged at a portion of the lateral surface 63 is defined as a lateral-surface external electrode 29.

In detail, among the first external electrode 20a, a portion arranged at the first end surface 62a is defined as a first end-surface external electrode 27a. Among the first external electrode 20a, a portion arranged at a portion of the first main surface 61a or a portion of the second main surface 61b is defined as a first main-surface external electrode 28a. Among the first external electrode 20a, a portion arranged at a portion of the first lateral surface 63a or a portion of the second lateral surface 63b is defined as a first lateral-surface external electrode 29a.

In addition, for the second external electrode 20b, similarly to the first external electrode 20a, a portion arranged at the second end surface 62b among the second external electrode 20b is defined as the second end-surface external electrode 27b. Among the second external electrode 20b, a portion arranged at a portion of the first main surface 61a or a portion of the second main surface 61b is defined as a second main-surface external electrode 28b. Among the second external electrode 20b, a portion arranged at a portion of the first lateral surface 63a or a portion of the second lateral surface 63b is defined as a second lateral-surface external electrode 29b.

### Layer Configuration of External Electrode

The layer configuration of the external electrode 20 will be explained based on FIG. 2. The external electrode 20 includes a base electrode layer 21 and a plated layer 23. The plated layer 23 includes an inner plated layer 24 and a surface plated layer 25. These layers are arranged from the end surface 62 of the multilayer body 2 in the order of the base electrode layer 21, inner plated layer 24, and surface plated layer 25. In detail, the first external electrode 20a includes a first base electrode layer 21a and a first plated layer 23a. The first plated layer 23a includes a first inner plated layer 24a and a first surface plated layer 25a. Similarly, the second external electrode 20b includes a second base electrode layer 21b and a second plated layer 23b. The second plated layer 23b includes a second inner plated layer 24b and a second surface plated layer 25b.

### Base Electrode Layer

The first base electrode layer 21a is arranged on the first end surface 62a of the multilayer body 2, and covers the first end surface 62a. The first base electrode layer 21a extends from the first end surface 62a to a portion of the first main surface 61a, a portion of the second main surface 61b, a portion of the first lateral surface 63a and a portion of the second lateral surface 63b.

Similarly, the second base electrode layer 21b is arranged on the second end surface 62b of the multilayer body 2, and covers the second end surface 62b. The second base electrode layer 21b extends from the second end surface 62b to a portion of the first main surface 61a, a portion of the second main surface 61b, a portion of the first lateral surface 63a and a portion of the second lateral surface 63b.

### Fired Layer

The first base electrode layer 21a and second base electrode layer 21b are configured as fired layers. The fired layer includes a glass component and metal. The glass composition includes, for example, at least one of B, Si, Ba, Mg, Al, Li and the like. The metal, for example, includes at least one of Cu, Ni, Ag, Pd, Ag-Pd alloy, Au and the like. The fired layer may include a plurality of layers. The fired layer is provided by coating a conductive paste including the glass component and metal on the multilayer body 2, and subsequently firing. This firing, i.e., baking, may be simultaneous with the baking of the internal electrode layer 10, or may be separate baking after baking the internal electrode layer 10.

The thickness of the first fired layer and second fired layer at a central portion in the lamination direction T of the first base electrode layer 21a located at the first end surface 62a and the second base electrode layer 21b located at the second end surface 62b, for example, is preferably at least about 3 μm and no more than about 25 μm.

In the case of providing a fired layer on the first main surface 61a and second main surface 61b, as well as the first lateral surface 63a and second lateral surface 63b, the thickness of the fired layer at the central portion in the length direction of the base electrode layer 21 on each surface, for example, is preferably at least about 3 μm and no more than about 25 μm.

### Plated Layer

The plated layer 23 on the base electrode layer 21 will be explained. As described above, in the present example embodiment, the plated layer 23 includes the inner plated layer 24 and surface plated layer 25. In other words, the plated layer 23 includes two layers. However, the plated layer 23 may be a single layer or a plurality of layers.

In the case of the plated layer 23 including two layers, it is preferable that a Ni plated layer and a Sn plated layer are provided from the lower layer. In addition, in the case of providing the plated layer including three layers, it is preferable that an Sn plated layer, Ni plated layer and Sn plated layer are provided from the lower layer. A preferred layer structure, for example, is a two-layer structure including Ni plating and Sn plating. Hereinafter, a case of the plated layer 23 being the two layers of the inner plated layer 24 and surface plated layer 25 will be explained.

### Inner Plated Layer

The inner plated layer 24 is provided on the base electrode layer 21, and covers at least a portion of the base electrode layer 21.

### Surface Plated Layer

The surface plated layer 25 is provided on the inner plated layer 24, and covers at least a portion of the inner plated layer 24.

Including the inner plated layer 24 and surface plated layer 25, the plated layer 23, for example, preferably includes at least one of metals such as Cu, Ni, Ag, Pd, Au and Sn, and alloys such as Ag-Pd alloys. For example, the inner plated layer 24 is preferably a Ni plated layer, and the surface plated layer 25 is preferably a Sn plated layer.

The Ni plated layer can prevent the base electrode layer 21 from being eroded by solder upon mounting the multilayer ceramic electronic component 1. The Sn plated layer can improve wettability of solder upon mounting the multilayer ceramic electronic component 1, and thus facilitates mounting. For this reason, by providing the surface plated layer 25 as a Sn plated layer, it is possible to improve the wettability of solder to the external electrode 20. The thickness per layer of the plated layer is, for example, preferably at least about 3 μm and no more than about 9 μm.

### Internal Structure of Multilayer Body (WT Cross Section)

The internal structure of the multilayer body 2 will be explained based on FIG. 3. FIG. 3 is a cross-sectional view along the line II-II of the multilayer ceramic electronic component 1 shown in FIG. 1. The internal structure shown in FIG. 3 is an internal structure viewed from the second end surface 62b. The multilayer body 2 is divided into the electrode opposing portion 50 and W gap 52 in the width direction W. The electrode opposing portion 50 of the section in the width direction W is defined as a W opposing portion 50b. In addition, the W gap 52 includes a first W gap 52a and a second W gap 52b.

The W opposing portion 50b is a portion at which the internal electrode layer 10 opposes in the lamination direction T. The W gap 52 is a portion in the width direction W at which neither of the first internal electrode layer 10a and the second internal electrode layer 10b are arranged in the lamination direction T.

The W gap 52 is located, in the width direction W of the multilayer body 2, between the W opposing portion 50b and first lateral surface 63a, and between the W opposing portion 50b and second lateral surface 63b. More specifically, the first W gap 52a is located between the W opposing portion 50b and first lateral surface 63a. The second W gap 52b is located between the W opposing portion 50b and second lateral surface 63b.

In other words, the first W gap 52a is located between an end of the internal electrode layer 10 on the side of the first lateral surface 63a and the first lateral surface 63a. In addition, the second W gap 52b is located between an end of the internal electrode layer 10 on the side of the second lateral surface 63b and the second lateral surface 63b.

The first W gap 52a and second W gap 52b are arranged so as to sandwich the W opposing portion 50b. The first W gap 52a and second W gap 52b include only the ceramic layer 4 without the internal electrode layer 10. The first W gap 52a and second W gap 52b define and function as a protective layer of the internal electrode layer 10.

The length in the width direction W of the W gap 52, for example, can be set to at least about 20% and no more than about 30% of the length in the width direction W of the multilayer body 2. In addition, the length in the width direction W of the W gap 52, for example, can be set to at least about 5 μm and no more than about 50 μm. The length in the width direction W of the W gap 52 will be explained specifically later.

### Size of Multilayer Ceramic Electronic Component

The size of the multilayer ceramic electronic component 1 is not particularly limited. The size of the multilayer ceramic electronic component 1, for example, can be provided in the following way. The dimension in the length direction L of the multilayer ceramic electronic component 1 including the multilayer body 2 and external electrode 20 is called L dimension. The L dimension is preferably at least about 0.25 mm and no more than about 1.0 mm. The dimension in the lamination direction T of the multilayer ceramic electronic component 1 including the multilayer body 2 and external electrode 20 is called T dimension. The T dimension is preferably at least about 0.125 mm and no more than about 0.5 mm. The dimension in the width direction W of the multilayer ceramic electronic component 1 including the multilayer body 2 and external electrode 20 is called W dimension. The W dimension is preferably at least about 0.125 mm and no more than about 0.5 mm. The length of each portion of the multilayer body 2 and external electrode 20 can be measured by a micrometer or optical microscope, for example.

In addition, in the present example embodiment, an example will be explained of the multilayer ceramic electronic component 1 being a 2-terminal multilayer ceramic capacitor. However, the multilayer ceramic electronic component 1 is not limited to being a 2-terminal multilayer ceramic capacitor, and can be a multi-terminal multilayer ceramic capacitor including three or more terminals.

### Compound Region

The multilayer ceramic electronic component 1 according to the present example embodiment has a characteristic of including a compound region 8 provided to the multilayer body 2. The compound region 8 is provided to an edge portion 7 of the multilayer body 2. Edge portion 7 of the multilayer body 2 refers to a surface-neighboring portion of the multilayer body 2. The compound region 8 is provided to a portion of the ceramic layer 4. More specifically, the compound region 8 is provided to the ceramic layer 4 constituting the edge portion 7 of the multilayer body 2. Edge portion 7 indicates a surface-neighboring portion of the multilayer body 2. Compound region 8 refers to a region having higher content ratio of Cu than other portions among the ceramic layers 4.

Based on FIG. 2, the compound region 8 will be explained. FIG. 2 shows the compound region 8 provided to the first edge portion 7a, which is an edge portion 7 in the lamination direction T of the multilayer body 2. The compound region 8 is also provided to the second edge portion 7b, which is the edge portion 7 in the width direction W of the multilayer body 2. This will be explained later based on FIG. 4.

As shown in FIG. 2, the first compound region 8a extending towards the first end surface 62a is provided to the edge portion 7a of the multilayer body 2. The first compound region 8a is provided to each of the first main surface 61a and second main surface 61b of the multilayer body 2. In addition, the second compound region 8b extending towards the second end surface 62b is provided to the first edge portion 7a of the multilayer body 2. The second compound region 8b is provided to each of the first main surface 61a and second main surface 61b of the multilayer body 2, similarly to the first compound region 8a.

### Joining of Compound Region

The first compound region 8a is preferably joined with the first base electrode layer 21a. In addition, the second compound region 8b is preferably joined with the second base electrode layer 21b.

In addition, the first compound region 8a is not joined with the second compound region 8b. When the first compound region 8a is joined with the second compound region 8b, the first external electrode 20a and second external electrode 20b are conductive. This is because a short circuit occurs in the multilayer ceramic electronic component 1.

More preferably, the first compound region 8a is not located more to a side of a position 70 at the center in the length direction L of the multilayer body 2 than the first base electrode layer 21a arranged on the first main surface 61a and second main surface 61b. This position 70 at the center is referred to as a multilayer body central position 70. Similarly, the second compound region 8b more preferably is not located more to a side of the multilayer body central position 70 than the second base electrode layer 21b arranged at the first main surface 61a and second main surface 61b.

FIG. 2 shows a leading end portion of the first compound region 8a on the side of the multilayer body central position 70 as a first region leading end portion 71a. In addition, the leading end portion of the first base electrode layer 21a on the side of the multilayer body central position 70 is shown as a first base leading end portion 72a. As shown in FIG. 2, the first region leading end portion 71a is located at a position closer to the first end surface 62a than the first base leading end portion 72a.

This also applies to the second compound region 8b. FIG. 2 shows the leading end portion of the second compound region 8b on the side of the multilayer body central position 70 as a second region leading end portion 71b. In addition, a leading end portion of the second base electrode layer 21b on the side of the multilayer body central position 70 is shown as a second base leading end portion 72b. As shown in FIG. 2, the second region leading end portion 71b is located at a position closer to the second end surface 62b than the second base leading end portion 72b.

FIG. 2 shows the distance in the length direction L between the first region leading end portion 71a and first base leading end portion 72a by distance d1. In addition, the distance in the length direction L between the second region leading end portion 71b and the second base leading end portion 72b is shown by distance d2. The distance d1 and distance d2, for example, are preferably at least about 3 μm and no more than about 1000 μm.

The first region leading end portion 71a is located more to the side of the first end surface 62a than the first base leading end portion 72a, and the second region leading end portion 71b is located more to the side of the second end surface 62b than the second base leading end portion 72b, such that it is possible to sufficiently obtain a distance in the length direction L between the first compound region 8a and second compound region 8b. It is thereby possible to decrease the risk of the occurrence of short circuit by the first compound region 8a and second compound region 8b shorting.

The compound region 8 is a region having higher content ratio of Cu than other portions among the ceramic layers 4, as described above. By such a compound region 8 being provided to the edge portion 7 of the multilayer body 2, the bonding force between the ceramic layer 4 and base electrode layer 21 increases from the mutual diffusion between the ceramic layer 4 and base electrode layer 21, whereby it is possible to decrease the risk of peeling.

### Thickness of Compound Region

The thickness in a direction orthogonal or substantially orthogonal to the first base electrode layer 21a of the first compound region 8a is shown as a thickness d3 in FIG. 2. The thickness d3 is, for example, preferably at least about 4 um and no more than about 25 um. Similarly, the thickness in a direction orthogonal to the second bas electrode layer 21b of the second compound region 8b is defined as thickness d4. The thickness d4 is, for example, preferably at least about 4 um and less than about 25 um.

When setting the thickness d3 of the first compound region 8a and thickness d4 of the second compound region 8b to no more than about 5 um, adherence between the first compound region 8a and first base electrode layer 21a, and adherence between the second compound region 8b and second base electrode layer 21b is not sufficiently established. On the other hand, when setting the thickness d3 of the first compound region 8a and thickness d4 of the second compound region 8b to at least about 25 um, dielectric loss occurs and the ESR increases. For the above reason, the thickness d3 of the first compound region 8a and the thickness d4 of the second compound region 8b are, for example, preferably at least about 4 um and less than about 25 um.

### Components of Compound Region

The main component of the first compound region 8a is preferably Cu, for example. Similarly, the main component of the second compound region 8b is preferably Cu, for example. By setting the main component of the compound region 8 as Cu, it is possible to further improve the adhesive force between the multilayer body 2 and base electrode layer 21 by the interdiffusion with the base electrode layer 21.

The component of the compound region 8 is, for example, more preferably at least about 80% Cu of the compound region 8. Even more preferably, for example, Cu is at least about 60% of the compound region 8.

### Analysis of Components

The calculation method of the main component of the compound region 8 will be explained. The main component can be obtained by the sequence of the following (1) to (3).

(1) Cross sectioning is performed on the multilayer body 2 to be parallel or substantially parallel to the direction linking the first lateral surface 63a and second lateral surface 63b of the multilayer body 2.

(2) For the exposed cross section, EDX (Energy Dispersive X-ray Spectroscopy) or WDX (Wavelength Dispersive X-ray Spectroscopy) elemental analysis is performed.

(3) The component most abundantly included per unit area is defined as the main component.

As described above, the main component of the compound region 8 is Cu, for example. In addition, the compound region 8 preferably contains Cu in at least about 60%, for example. It is thus possible to further raise the adhesive force between the ceramic layer 4 and base electrode layer 21, and by extension, the adhesive force between the multilayer body 2 and base electrode layer 21.

### Thickness Measurement Method

The thickness measurement method of the compound region 8 will be explained. The thickness can be obtained by the sequence of the following (1) to (3).

(1) Cross sectioning is performed on the multilayer body 2 to be parallel or substantially parallel to the direction linking the first lateral surface 63a and second lateral surface 63b of the multilayer body 2.

(2) The thickness of the base electrode layer 21 is measured using a digital microscope.

(3) Based on SEM (Scanning Electron Microscope) upon analysis for the aforementioned components, the region including at least about 60% Cu is provided.

(4) From the region specified in (3), the thickness of the compound region 8 is calculated by subtracting the thickness of the base electrode layer 21 measured in (2).

### Compound Region in Width Direction

As described earlier, the compound region 8 is also provided to the second edge portion 7b, which is an edge portion 7 in the width direction W of the multilayer body 2. It will be explained based on FIG. 4. FIG. 4 is a cross-sectional view along the line in FIG. 1, and is a view showing the WL cross section of the multilayer ceramic electronic component 1. As shown in FIG. 4, the third compound region 8c extending to the first end surface 62a is provided to the second edge portion 7b of the multilayer body 2. A third compound region 8c is provided to each of the first lateral surface 63a and second lateral surface 63b of the multilayer body 2. In addition, a fourth compound region 8d stretched to the second end surface 62b is provided to the second edge portion 7b of the multilayer body 2. The fourth compound region 8d is provided to each of the first lateral surface 63a and second lateral surface 63b of the multilayer body 2, similarly to the third compound region 8c.

The third compound region 8c and fourth compound region 8d have the same or similar configurations, characteristics, etc. as the first compound region 8a and second compound region 8b described earlier.

### Length of L Gap

The length of the L gap 51 will be explained. As shown in FIG. 2, the length in the length direction L of the multilayer body 2 is defined as d6. In addition, the length in the length direction L of the multilayer body 2, of the first L gap 51a and second L gap 51b is defined as d5. The length d5 of the L gap 51 is, for example, preferably at least about 10% and no more than about 30% of the length d6 of the multilayer body 2. In other words, (length d5 in length direction L of multilayer body 2 of L gap 51)/(length d6 in length direction L of multilayer body 2) is, for example, preferably at least about 0.10 and no more than about 0.30. When this ratio is no more than about 0.10, there is concern over the internal electrode layer 10 and external electrode 20 conducting at an unexpected location. On the other hand, if this ratio is at least about 0.30, there is concern over the L gap 51 becoming large, and a structural defect tending to arise due to a level difference.

### Dummy Electrode Layer

A case of a dummy electrode layer 14 being arranged on the L gap 51 will be explained. FIG. 4 shows a configuration in which the dummy electrode layer 14 is arranged at the second L gap 51b. FIG. 4 shows the leading end portion of the first internal electrode layer 10a on a side of the second end surface 62b as an internal electrode leading end portion 73. In addition, a leading end portion of the dummy electrode layer 14 on a side of the first end surface 62a is shown as a dummy electrode layer leading end portion 74. The length in the length direction L between the internal electrode leading end portion 73 and dummy electrode layer leading end portion 74 is defined as d7. This length d7 is, for example, preferably at least about 10% and no more than about 30% of the length d6 in the length direction L of the multilayer body 2. It is not necessary for the dummy electrode layer 14 to be arranged in all layers of the inner layer portion 53 of the multilayer body 2. For example, only one outermost layer of the inner layer portion 53 may be provided. Outermost layer indicates a layer closest to any main surface 61 among the layers on which the internal electrode layer 10 is arranged.

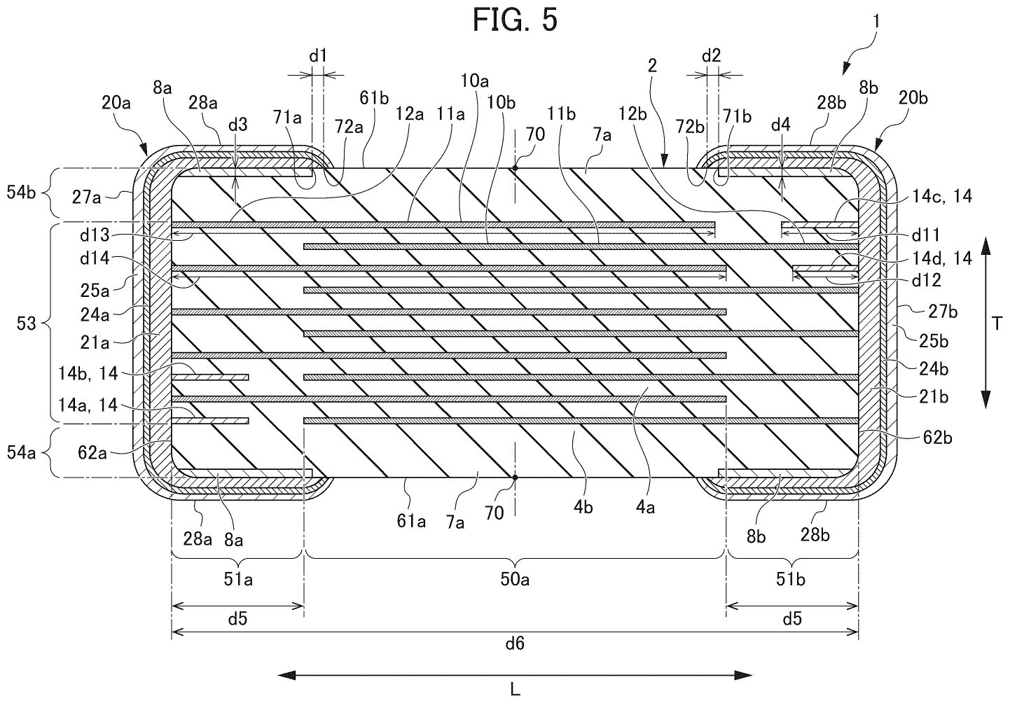

An example of the arrangement of the dummy electrode layer 14 will be explained based on FIG. 5. FIG. 5 is a view corresponding to a cross-sectional view along the line I-I in FIG. 1 illustrating the dummy electrode layers 14. As shown in FIG. 5, the dummy electrode layers 14 can include at least one among the second dummy electrode layer 14c 14d exposed at the second end surface 62b arranged on the same plane as the first internal electrode layer 10a, and the first dummy electrode layers 14a 14b exposed at the first end surface 62a, arranged on the same plane as the second internal electrode layer 10b.

For the length in the length direction L of the dummy electrode layer 14, the length of the dummy electrode layer 14 at the outermost surface, i.e. dummy electrode layer 14 closest to the first main surface 61a or second main surface 61b, is longer than the length of other dummy electrode layers 14. In addition, for the length in the length direction L of the internal electrode layer 10, the length of the internal electrode layer 10 arranged on the same plane as the dummy electrode layer 14 of the outermost surface is shorter than the length of other internal electrode layers 10. The same plane referred to herein indicates a laminated surface parallel or substantially parallel to the LW plane.

An example thereof is shown in FIG. 5. The second dummy electrode layer 14c is a dummy electrode layer 14 closest to the second main surface 61b. The length in the length direction L of the second dummy electrode layer 14c is defined as length d11. The second dummy electrode layer 14d is a dummy electrode layer 14 located next to the second dummy electrode layer 14c, and more to the first main surface 61a than the second dummy electrode layer 14c. The length in the length direction L of the second dummy electrode layer 14d is defined as length d12. The length d11 is longer than the length d12.

The length in the length direction L of the first internal electrode layer 10a will be explained. The length in the length direction L of the first internal electrode layer 10a arranged on the same plane as the second dummy electrode layer 14c is defined as length d13. In addition, the length in the length direction L of the first internal electrode layer 10a arranged on the same plane as the second dummy electrode layer 14d is defined as length d14. The length d13 is shorter than the length d14.

In FIG. 5, the lengths in the length direction L of the first dummy electrode layers 14a 14b are the same or substantially the same, and the second internal electrode layer 10b arranged on the same plane as these also has the same or substantially the same length in the length direction L of these. However, for the first dummy electrode layers 14a, 14b and the second internal electrode layer 10b arranged on the same plane as these, it is possible to provide a similar arrangement as the second dummy electrode layer 14c, 14d explained above.

### W Gap

The length of the W gap 52 will be explained. As shown in FIG. 3, the length in the width direction W of the multilayer body 2 is defined as d8. In addition, the length in the width direction W of the multilayer body 2 of the first W gap 52a and second W gap 52b is defined as d9. The length d8 of the W gap 52 is, for example, preferably at least about 20% and no more than about 30% of the length d9 in the width direction W of the multilayer body 2. In other words, (length d9 in width direction W of multilayer body 2 of W gap 52)/(length d8 in width direction W of multilayer body 2) is, for example, preferably at least about 0.20 and no more than about 0.30.

### Measurement Method of Gap Length

The lengths of the L gap 51, W gap 52, etc. can be measured by polishing the multilayer body 2 in a direction parallel or substantially parallel to the LW plane until one of the outermost layers of the multilayer body 2 to expose the internal electrode layer 10, and observing the exposed surface with a digital microscope. In the case of the dummy electrode layer 14 being arranged, it is polished until one of the outermost layers, and the length d7 of the outermost layer is measured.

### Definition of Path Length

The definition of the path length will be explained. The lengths of the internal electrode layer 10, dummy electrode layer 14, etc. can be measured as follows. In other words, the border line of the internal electrode layer 10 is set in a range of, for example, at least about 92% and no more than about 103% of the ideal border line of the internal electrode layer 10. By setting the path length to such a range, the path length will not become too long, a result of which it is possible to reduce or prevent influence on ESR. In addition, by setting the path length to such a range, the path length will not become too short, as a result of which it is possible to reduce or prevent the capacitance from decreasing too much. The border line was measured by polishing the multilayer body 2 in a direction parallel or substantially parallel to the LW plane until one of the outermost layers of the multilayer body 2 to expose the internal electrode layer 10, and the exposed surface was observed by a digital microscope. At this time, the internal electrode layer 10 and ceramic layer 4 were differentiated by binarizing into conductive components and other components. The ideal border line, as shown in FIG. 4, was calculated by tying the end point 80 and end point 81, which are two end points in the width direction W of the exposed portion of the internal electrode layer 10 extending to the end surface 62, and the end point 82 and end point 83, which are two end points in the width direction W of the internal electrode layer 10 located at the multilayer body central position 70 that is the center in the length direction L of the multilayer body 2. At this time, neither the actual border line, and the ideal border line include a border line when linking the end point 80 and end point 81 of the exposed portion of the internal electrode layer 10. In addition, in the case of the dummy electrode layer 14 being arranged, it is similarly polished until one of the outermost layers, and the path length of the internal electrode layer 10 there is measured.

### Production Method of Multilayer Ceramic Electronic Component

Next, a production method of the multilayer ceramic electronic component will be explained with an example of the multilayer ceramic electronic component 1. In the following explanation, an example of a production method of the multilayer ceramic electronic component 1 according to the present example embodiment will be explained focusing on the characteristic portions.

### Preparation of Multilayer Block

A ceramic sheet and conductive paste for the internal electrode layer are prepared. A binder and solvent are included in the ceramic sheet and conductive paste for internal electrode layer. This binder and solvent can use a known organic binder and organic solvent. On the ceramic sheet, for example, the conductive paste for internal electrode layer is printed in a predetermined pattern by, for example, screen printing, gravure printing or the like to form the pattern of the internal electrode layer 10. A predetermined number of ceramic sheets for the outer layer portion 54 on which the pattern of the internal electrode layer 10 is not printed are laminated, the ceramic sheets on which the pattern of the internal electrode layer 10 was printed are laminated in order thereon, a predetermined number of ceramic sheets for the one other outer layer portion 54 are laminated thereon to prepare the multilayer sheet. The multilayer sheet is pressed in the lamination direction by a measure such as, for example, hydrostatic pressing to prepare the multilayer block.

### Preparation of Multilayer Chip

The multilayer block is cut into a predetermined size to cut out a multilayer chip. At this time, the corner portions and ridge portions of the multilayer chip may be rounded by, for example, barrel polishing or the like. The multilayer chip becomes the multilayer body 2 by firing.

### Firing

Next, the multilayer chip is fired to prepare a multilayer body 2. The firing temperature depends on the materials of the ceramic layer 4 and the internal electrode layer 10, but is, for example, preferably about 900° C. or higher and about 1400° C. or lower.

### External Electrode

Next, formation of the external electrodes 20 will be explained.

### Base Electrode Layer

The conductive paste which becomes the base electrode layer 21 is coated on two end surfaces 62 of the multilayer body 2 to form the base electrode layer 21. In order to form a fired layer, the conductive paste including glass component and metal is coated by a method such as dipping, for example, and subsequently firing treatment is performed to form the base electrode layer 21.

The temperature of the firing treatment at this time is, for example, preferably at least about 500° C. and no more than about 900° C. In addition, the time of firing treatment at this time is, for example, preferably at least about 30 minutes and no more than about 2 hours. In addition, the atmosphere of the firing treatment at this time is preferably, for example, a reducing atmosphere including H₂O or H₂. It is possible to further increase the thickness of the compound region 8 by raising the firing temperature, and lengthening the firing time. Subsequently, plating may be conducted on the surface of the fired layer as necessary.

Next, a plated layer 23 is formed on the surface of the base electrode layer 21. In the present example embodiment, for example, a Ni plated layer is formed on the fired layer. This Ni plated layer becomes the inner plated layer 24. Next, a Sn plated layer is formed on the Ni plated layer. This Sn plated layer becomes the surface plated layer 25. The Ni plated layer and Sn plated layer are sequentially formed by a barrel plating method, for example. The multilayer ceramic capacitor 1 is thus obtained.

### Characteristic Evaluation of Multilayer Ceramic Electronic Component

Characteristic evaluation of the multilayer ceramic electronic component 1 will be explained.

### (1) Evaluation Chip

A multilayer ceramic capacitor as a multilayer ceramic electronic component was established as the evaluation chip. The dimensions were set, for example, as the length in the length direction L of about 0.62 mm, length in the width direction W of about 0.31 mm, and length in the lamination direction T of about 0.31 mm. The ceramic material was, for example, CaZrO₃. The capacitance was set at, for example, about 4.7 pF, and the rated voltage at about 25 V.

### (2) Structure of External Electrode

A base electrode layer was provided as an electrode layer including Cu as the conductive metal, and a glass component. Film thickness on end surface 62 was set to, for example, about 10 um. The film thickness at a central portion in the length direction L of the base electrode layer 21 located on the first main surface 61a and second main surface 61b, and the first lateral surface 63a and second lateral surface 63b was set to, for example, about 6 μm.

A metal layer was provided as a metal layer including a plated layer. As the plated layer, the two layers of a Ni plated layer and Sn plated layer were formed. The film thickness of the Ni plated layer was set as follows. The film thickness of the end surface 62 was, for example, about 4 um. The film thickness at the central portion in the length direction of the Ni plated layer located on the first main surface 61a and second main surface 61b, and the first lateral surface 63a and second lateral surface 63b was set to, for example, about 4 μm.

The film thickness of the Sn plated layer was set as follows. The film thickness of the end surface 62 was, for example, about 4 um. The film thickness at the central portion in the length direction of the Sn plated layer located on the first main surface 61a and second main surface 61b, and the first lateral surface 63a and second lateral surface 63b was set to, for example, about 4 μm.

### (3) Contents of Evaluation

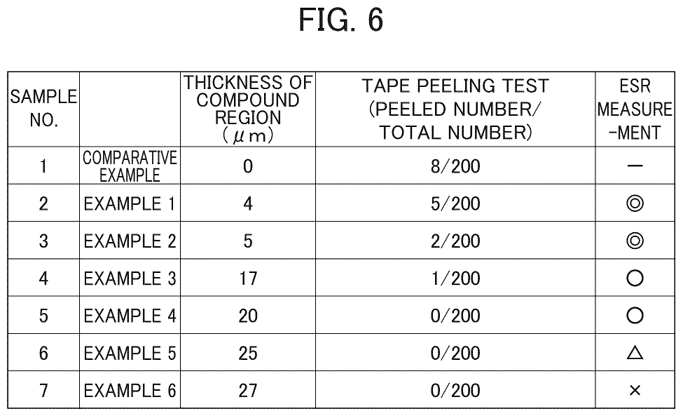

The evaluation results for characteristics of the evaluation chip will be explained based on FIG. 6. FIG. 6 is a table showing the evaluation results for the characteristics. Seven evaluation chips having different thicknesses of the compound region 8 were prepared as shown in FIG. 6. One comparative example and six examples are included among the seven evaluation chips. The evaluation items are a tape peeling test and ESR measurement.

### Tape Peeling Test

Adhesive tape (CT-24 manufactured by Nichiban) having the adhesion force of about 10 N per about 25 mm was pressed and peeled off from two hundred multilayer ceramic electronic components. Then, the number on which peeling occurred were counted.

### ESR Measurement

Heat treatment was performed for about 1 hour at about 150° C. on the multilayer ceramic electronic component before ESR measurement in an air atmosphere, it was subsequently mounted on a substrate for measurement, and ESR was measured using a network analyzer with a measurement frequency of 1 MHz after 24 +/−2 hours after heat treatment completion. One hundred units were measured and the average value thereof was evaluated. Evaluation, when based on the evaluation chip of sample no. 1, determined ESR according to:
⊚: no more than about 105% of ESR of sample no. 1
○: about 105%≤ESR110% of ESR of sample no. 1
Δ: about 110%≤ESR115% of ESR of sample no. 1
x: greater than about 115% of ESR of sample no. 1

In Examples 1 to 6 on which the compound region 8 is formed, it was possible to reduce or prevent the peeled number in the tape peeling test to no more than five among two hundred samples. In addition, in the range of thickness of the compound region of no more than about 25 μm, favorable EST measurement was obtained. In addition, in Example 1 having a thickness of the compound region of about 4 μm, and in Example 2 having a thickness of the compound region of about 5 μm, particularly favorable results were obtained in the ESR test.

Although example embodiments of the present invention have been described above, the present invention is not limited to the example embodiments described above, and various changes and modifications thereto are possible.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including:
a plurality of ceramic layers which are laminated;
the plurality of ceramic layers including Ca and Zr as main components;
a first main surface and a second main surface opposing each other in a lamination direction;
a first lateral surface and a second lateral surface opposing each other in a width direction orthogonal or substantially orthogonal to the lamination direction;
a first end surface and a second end surface opposing each other in a length direction orthogonal or substantially orthogonal to the lamination direction and the width direction;
a first internal electrode layer alternately laminated with the plurality of ceramic layers, and exposed at the first end surface; and
a second internal electrode layer alternately laminated with the plurality of ceramic layers, and exposed at the second end surface;
a first external electrode extending from the first end surface to the first main surface and the second main surface; and
a second external electrode extending from the second end surface to the first main surface and the second main surface; wherein
the first external electrode and the second external electrode include:
a first base electrode layer and a second base electrode layer; and
a plated layer covering a portion of the first base electrode layer and the second base electrode layer;
the first base electrode layer and the second base electrode layer include Cu as a main component;
the multilayer body includes, at an edge portion in the lamination direction, a first compound region extending to the first end surface, and a second compound region extending to the second end surface;
the first compound region is joined with the first base electrode layer;
the second compound region is joined with the second base electrode layer; and
the first compound region and the second compound region are not joined together.

2. The multilayer ceramic electronic component according to claim 1, wherein the first compound region and the second compound region are not located closer to a central side in a length direction of the multilayer body than the first base electrode layer and the second base electrode layer on the first main surface and the second main surface, respectively.

3. The multilayer ceramic electronic component according to claim 1, wherein a thickness of the first compound region and a thickness of the second compound region in a direction orthogonal or substantially orthogonal to the first base electrode layer and the second base electrode layer are at least about 4 μm and no more than about 25 μm.

4. The multilayer ceramic electronic component according to claim 1, wherein a main component of the first compound region and the second compound region is Cu.

5. The multilayer ceramic electronic component according to claim 1, wherein
the multilayer body includes, at an edge portion in a width direction, a third compound region extending to the first end surface, and a fourth compound region extending to the second end surface;
the third compound region is joined with the first base electrode layer;
the fourth compound region is joined with the second base electrode layer; and
the third compound region and the fourth compound region are not joined to each other.

6. The multilayer ceramic electronic component according to claim 1, wherein
a portion at which the first internal electrode layer and the second internal electrode layer oppose each other in the lamination direction is defined as an electrode opposing portion;
between the electrode opposing portion and the first end surface, and between the electrode opposing portion and the second end surface in the length direction of the multilayer body are respectively defined as an L gap; and
a length in the length direction of the multilayer body of the L gap is at least about 10% and no more than about 30% of the length in the length direction of the multilayer body.

7. The multilayer ceramic electronic component according to claim 1, wherein
the multilayer body includes a first dummy electrode layer on a same plane as the first internal electrode layer, and exposed at the second end surface; and
a distance in the length direction of the multilayer body between a leading end of the first internal electrode layer on a side of the second end surface, and a leading end of the first dummy electrode layer on a side of the first end surface is at least about 10% and no more than about 30% of the length in the length direction of the multilayer body.

8. The multilayer ceramic electronic component according to claim 7, wherein the first dummy electrode layer is on a same plane as the first internal electrode layer closest to either of the first main surface and the second main surface.

9. The multilayer ceramic electronic component according to claim 1, wherein the multilayer body includes:
a second dummy electrode layer on a same plane as the first internal electrode layer, and exposed at the second end surface; and
a first dummy electrode layer on a same plane as the second internal electrode layer, and exposed at the first end surface; and
a distance in the length direction of the multilayer body between a leading end of the first internal electrode layer on a side of the second end surface, and a leading end of the second dummy electrode layer on a side of the first end surface is at least about 10% and no more than about 30% of the length in the length direction of the multilayer body.

10. The multilayer ceramic electronic component according to claim 9, wherein
a plurality of the first dummy electrode layers are provided;
among the plurality of the first dummy electrode layers, a first dummy electrode layer closest to the first main surface or the second main surface has a longer length in the length direction than another first dummy electrode layer adjacent in the lamination direction to the first dummy electrode layer; and
the second internal electrode layer on the same plane as the first dummy electrode layer closest to the first main surface or the second main surface has a shorter length in the length direction than another of the second internal electrode layers on the same plane as another first dummy electrode layer adjacent in the lamination direction to the first dummy electrode layer.

11. The multilayer ceramic electronic component according to claim 9, wherein
a plurality of the second dummy electrode layers are provided;
among the second dummy electrode layers, a second dummy electrode layer closest to the first main surface or the second main surface has a longer length in the length direction than another of the second dummy electrode layers adjacent in the lamination direction to said second dummy electrode layer; and
the first internal electrode layer on the same plane as the second dummy electrode layer closest to the first main surface or the second main surface has a shorter length in the length direction than another of the first internal electrode layers disposed on the same plane as another of the second dummy electrode layers adjacent in the lamination direction to the second dummy electrode layer.

12. The multilayer ceramic electronic component according to claim 1, wherein a portion at which the first internal electrode layer and the second internal electrode layer oppose each other in the lamination direction is defined as an electrode opposing portion;
between the electrode opposing portion and the first lateral surface, and between the electrode opposing portion and the second lateral surface in the width direction of the multilayer body define a W gap, respectively; and
a length in the width direction of the multilayer body of the W gap is at least about 20% and no more than about 30% of the length in the width direction of the multilayer body.

13. The multilayer ceramic electronic component according to claim 1, wherein an actual border line of the first inner electrode layer or the second inner electrode layer is at least about 92% and no more than about 103% of an ideal path length of the first internal electrode layer or the second internal electrode layer which is opposing.

14. The multilayer ceramic electronic component according to claim 1, wherein the main component is a component included most abundantly in a unit area.

15. The multilayer ceramic electronic component according to claim 1, wherein a number of the plurality of ceramic layers is at least 5 and no more than 2000.

16. The multilayer ceramic electronic component according to claim 1, wherein each of the plurality of ceramic layers includes a Mn compound, an Fe compound, a Cr compound, a Co compound, or a Ni compound as a subcomponent.

17. The multilayer ceramic electronic component according to claim 1, wherein each of the plurality of ceramic layers includes a plurality of crystal grains including a perovskite component.

18. The multilayer ceramic electronic component according to claim 1, wherein a thickness of each of the plurality of ceramic layers is at least about 0.3 μm and no more than about 100 μm.

19. The multilayer ceramic electronic component according to claim 1, wherein a thickness of each of the first and second internal electrode layers is at least about 0.1 μm and no more than about 5.0 μm.

20. The multilayer ceramic electronic component according to claim 1, wherein a thickness of each of the first and second internal electrode layers is at least about 0.2 μm and no more than about 2.0 μm.
